(19) United States
(12) Patent Application Publication
(10) Pub. No.: US 2008/0129069 A1
(43) Pub. Date: Jun. 5, 2008

(54) MINIMALLY INVASIVE COVER FOR BEARING OF MOTOR HOME SLIDE-OUT

(75) Inventors: Boyd R. Vanover, Miami, OK (US); Richard Arnall, Miami, OK (US); Larry Kowal, Fairland, OK (US); Charles Michael Wood, Miami, OK (US)

Correspondence Address: HOVEY WILLIAMS LLP, 10801 Mastin Blvd., Suite 1000, Overland Park, KS, 66210, US

(73) Assignee: NEWELL COACH CORPORATION, Miami, OK (US)

(21) Appl. No.: 11/566,554

(22) Filed: Dec. 4, 2006

(51) Int. Cl. B60P 3/34

(52) U.S. Cl. 296/26.12

(57) ABSTRACT

An improved, space-saving, vehicle slide-out is slidably supported on a vehicle chassis by a bearing mechanism and is selectively positionable relative to the chassis between retracted and extended positions. The slide-out includes, among other things, sidewalls and a cover assembly operable to cover the corresponding sidewall and the bearing mechanism while using a minimal amount of internal vehicle space. Each cover assembly includes a base segment that at least partly receives the sidewall, with the base segment and sidewall cooperatively defining a gap. The cover assembly further includes a shiftable cover segment that is operable to cover the gap.

### BACKGROUND OF THE INVENTION

1. Field of the Invention

The present invention is broadly concerned with slide-outs used in motor homes or other types of vehicles for increasing the roominess of the vehicle. More particularly, embodiments of the present invention are concerned with such slide-outs, and especially the internal, shiftable cover assemblies forming a part thereof, which provide an aesthetically pleasing internal cover for the slide-out sidewalls while occupying only a minimum of valuable internal vehicle space.

2. Discussion of Prior Art

Many large RVs are provided with slide-outs which can be selectively extended when the vehicles are parked, in order to provide additional living space. Generally speaking, these slide-outs include top, bottom, sidewall, and outboard wall structure defining a complete enclosure, together with support and operating mechanism typically connected to the sidewalls. When retracted, the slide-out sidewalls extend into the confines of the RV, and must be covered for aesthetic reasons and also to protect the operating mechanism.

One type of slide-out commonly in use today is manufactured by Valid Manufacturing of Salmon Arm, BC. These Valid slide-outs are operated by an electric motor positioned below the slide-outs, and have upstanding support plates and slide mechanisms operably coupled with the slide-out sidewalls. In present practice, it is common to construct stationary upright sidewall covers secured to the slide-out which cover and protect the slide-out sidewalls and operating mechanism.

Prior art RV slide-outs are problematic and suffer from various undesirable limitations. For example, sidewall covers associated with prior art slide-outs extend a considerable distance (typically about 30 inches) into the RV interior when the slide-outs are fully retracted. Inasmuch as two such covers are present, it can be very difficult to walk through the RV without undue interference. There is accordingly a need in the art for improved slide-outs having sidewall covers which utilize a minimum of interior RV space when the slide-outs are retracted.

### SUMMARY OF THE INVENTION

The present invention provides a slide-out with a cover that does not suffer from the problems and limitations of prior art slide-outs set forth above.

A first aspect of the present invention concerns a vehicle having an interior living area. The vehicle broadly includes a vehicle chassis, a slide-out, and a bearing mechanism. The slide-out is moveable between retracted and extended positions, with the slide-out serving to expand the living area when in the extended position thereof. The slide-out includes a laterally-extending wall that shifts laterally relative to the vehicle chassis as the slide-out moves between the extended and retracted positions thereof. The bearing mechanism shiftably supports the slide-out on the chassis for movement between the extended and retracted positions. The slide-out includes a cover assembly disposed about at least a portion of the bearing mechanism so as to cover the at least a portion of the bearing assembly from the living area. The cover assembly includes a base segment that is moveable relative to the laterally-extending wall. The base segment and laterally-extending wall cooperatively define a gap that changes in size as the slide-out moves between the extended and retracted positions thereof. The cover assembly includes a cover segment that is in a covering relationship with the gap.

A second aspect of the present invention concerns a vehicle slide-out bearing cover operable to shift relative to one of the slide-out sidewalls as the slide-out moves between retracted and extended positions. The vehicle slide-out bearing cover broadly includes a base segment and a cover segment. The base segment presents an open-ended slot configured to shiftably receive the one sidewall of the slide-out as the slide-out moves between the extended and retracted positions. The base segment is adapted to define a variously sized gap within the slot as the slide-out moves between the extended and retracted positions. The cover segment is shiftable relative to the base segment. The cover segment is operable to be fixedly attached relative to the sidewall so as to be shiftable as the sidewall shifts into and out of the slot. The cover segment thereby covers the gap in the retracted and extended positions. The cover segment includes a first section and a second section that is swingable relative to the first section to a stowed position when the slide-out is in the retracted position thereof.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective view of a recreational vehicle constructed in accordance with a preferred embodiment of the present invention, showing a slide-out of the recreational vehicle in its fully extended position;

FIG. 2 is a fragmentary perspective view in partial section of the recreational vehicle shown in FIG. 1, showing the slide-out in its fully retracted position;

FIG. 3 is a fragmentary exploded view of the slide-out shown in FIGS. 1 and 2, showing a sidewall cover assembly of the slide-out including a lower sidewall segment and an associated sliding, sectionalized cover segment;

FIG. 4 is a fragmentary perspective view of the slide-out shown in FIGS. 1-3, showing the slide-out in the retracted position, an upper sidewall segment of the cover assembly and the lower sidewall segment, with parts broken away and partially in section, a bearing mechanism slidably attached to the slide-out, and further showing the cover assembly disposed about one of the slide-out sidewalls, with the shiftable cover segment thereof depicted in phantom in its stowed position;

FIG. 4a is a right side elevational view of the bearing mechanism shown in FIG. 4, when the slide-out is in its fully retracted position;

FIG. 5 is a fragmentary perspective view in partial section of the recreational vehicle shown in FIGS. 1 and 2, showing the slide-out shifted in an outboard direction from the fully retracted position to an intermediate position, with the fully retracted position being illustrated in phantom;

FIG. 6 is a fragmentary perspective view of the slide-out shown in FIGS. 1-4 and 5, showing the slide-out in an intermediate position, and further showing the shiftable cover segment depicted in phantom, with an inboard section of the cover segment being pivoted upwardly from the stowed position;

FIG. 6a is a right side elevational view of the bearing mechanism shown in FIGS. 4, 4a, and 6, showing the bearing mechanism while the slide-out is in the intermediate position;

FIG. 7 is a fragmentary perspective view in partial section of the recreational vehicle shown in FIGS. 1, 2, and 5, showing the slide-out shifted in the outboard direction from the intermediate position to the fully extended position, with the cover assembly being also shown in phantom when the slideout is in the intermediate position, and also showing the inboard section in the stowed position and in the upwardly pivoted position;

FIG. 8 is a fragmentary perspective view of the slide-out shown in FIGS. 1-4, 5, 6, and 7, showing the slide-out in the fully extended position, with the slide-out sidewall and lower sidewall cover segment defining a gap therebetween, and further showing the shiftable cover segment, depicted in phantom, in a covering position relative to the gap;

FIG. 8a is a right side elevational view of the bearing mechanism shown in FIGS. 4, 4a, 6, 6a, and 8, showing the bearing mechanism while the slide-out is in the fully extended position;

FIG. 9 is a fragmentary, cross-sectional view of the recreational vehicle shown in FIGS. 1, 2, 5, and 7, showing the bearing mechanism and cover assembly when the slide-out is in the fully retracted position;

FIG. 10 is a perspective view of a preferred gas spring assembly of the slide-out shown in FIGS. 1-4 and 5-9, showing gas springs with corresponding arms biased into an outwardly extending position; and

FIG. 11 is a perspective view of a multiple-section metallic slides of the slide-out shown in FIGS. 1-4 and 5-9, showing slide sections extended from one another.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

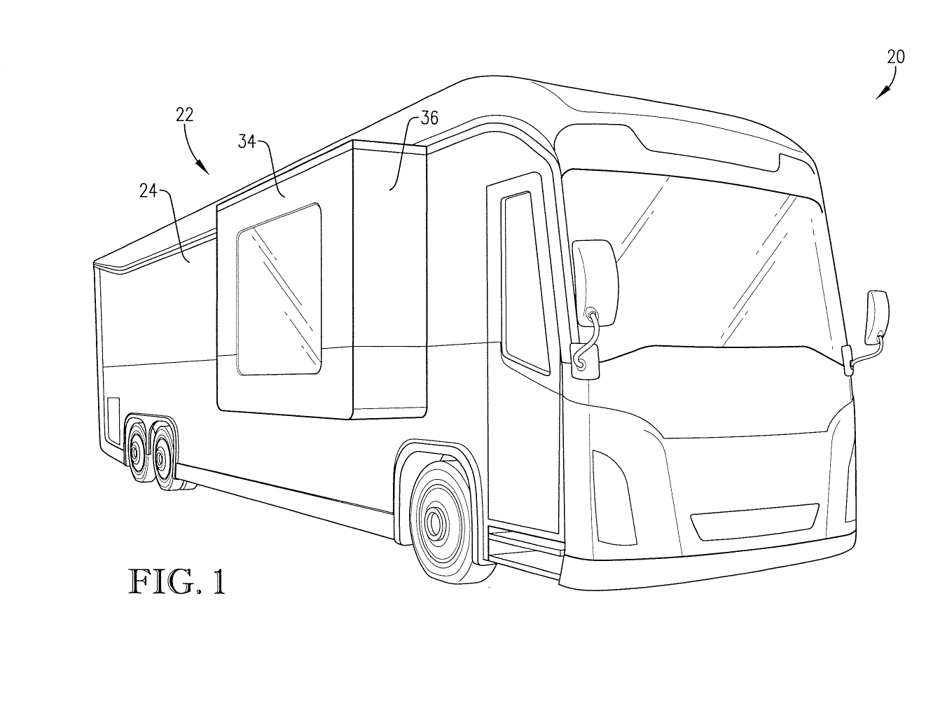

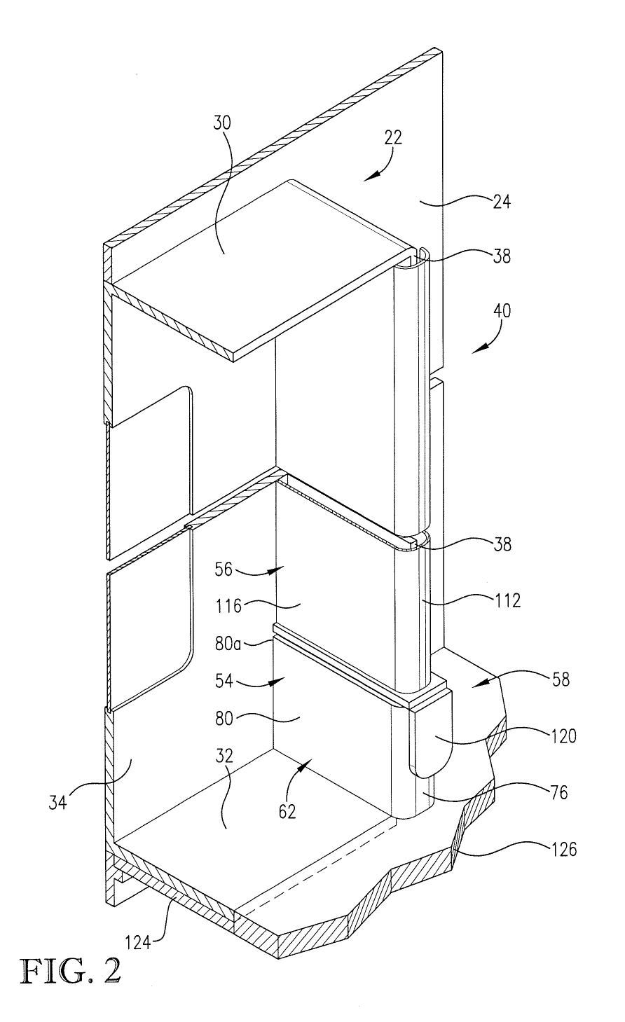

Turning now to the drawings, FIG. 1 illustrates an RV 20 of the usual type, preferably including a slide-out 22 installed along one sidewall 24 thereof. The slide-out 22 is selectively movable between a fully extended position illustrated in FIG. 1 and a fully retracted position (see FIG. 2) wherein the outboard wall of the slide-out 22 is substantially flush with the RV sidewall 24. While the slide-out 22 is incorporated into the illustrated RV 20, the principles of the present invention are also applicable where the slide-out 22 is included in other types of self-propelled vehicles or towed vehicles such as a trailer in order to effectively expand the internal space or living area. Furthermore, it is also within the ambit of the present invention to include more than one slide-out 22. As those of ordinary skill in the art will appreciate, multiple slide-outs 22 could be spaced along the same RV sidewall, along opposite sidewalls, or a combination of both. The RV 20 broadly includes, among other things, a chassis 26, the slide-out 22, and a bearing mechanism 28.

In more detail, the slide-out 22 broadly includes top wall 30, bottom wall 32, outboard wall 34, and a pair of opposed, inwardly extending sidewalls 36,38. The walls 24,30,32,34,36,38 are preferably interconnected so as to provide a fully enclosed RV 20. The overall slide-out 22 also is slidably supported on the chassis 26 with the bearing mechanism 28, as will be discussed in greater detail. The RV 20 further includes a drive mechanism (not shown) designed to selectively power the slide-out 22 between the extended position illustrated in FIG. 1 and the fully retracted position depicted in FIG. 2. Also, a pair of generally upright, segmented sidewall cover assemblies 40 form a part of the slide-out 22, and are operable to cover the sidewalls 36,38 and bearing mechanism 28, as will be further described. In this manner, the cover assemblies 40 each serve as a false wall that provides various advantages such as preserving the internal appearance of the RV with minimum use of internal space as well as concealing or covering the bearing mechanism 28 from within the living area. While the illustrated cover assemblies 40 are used to cover the sidewalls 36,38 and bearing mechanism 28, it is also within the ambit of the present invention where the cover assemblies 40 cover other components of the slide-out 22 or chassis 26.

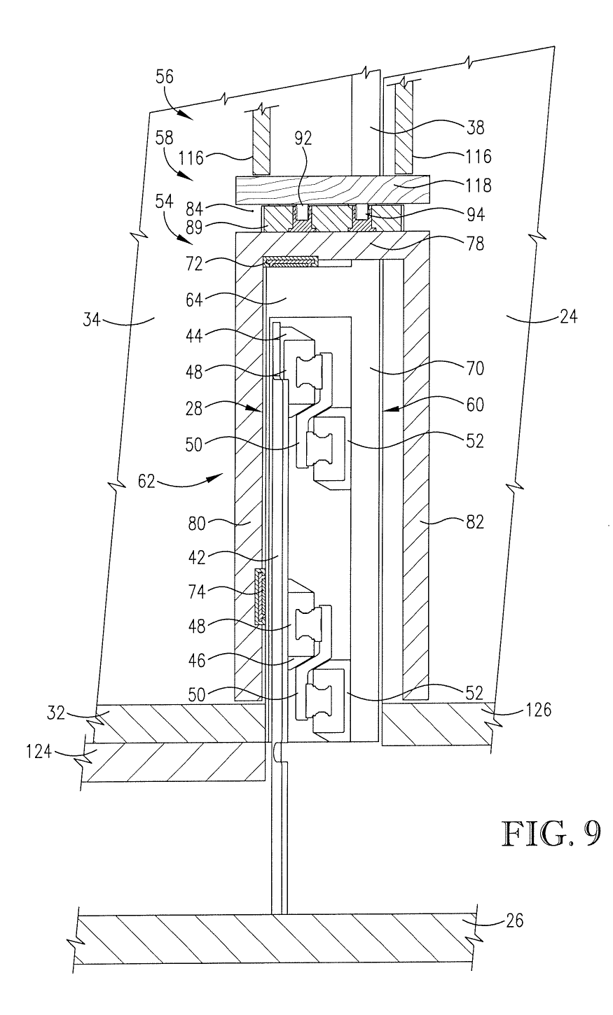

The slide-out 22 is slidably supported on the chassis 26 by the bearing mechanism 28. The bearing mechanism 28 includes a pair of upright, stationary, primary plates 42, with only one of the pair being illustrated herein, which are secured to the chassis 26 of the RV 20 (see FIG. 9). The plates 42 are located adjacent to respective sidewalls 36,38 and are operably connected thereto through a pair of double-acting upper and lower slide assemblies 44,46, with only one set of slide assemblies 44,46 being illustrated. Each of these assemblies 44,46 includes a stationary fixture 48 secured to the plate 42, with the remainder of the assemblies 44,46 being shiftable relative thereto. To this end, the assemblies 44,46 have an elongated slide arm 50 with an outer sliding fixture 52 slidably coupled thereto. The fixtures 52 are in turn secured to the slide-out sidewalls 36,38. While the illustrated bearing mechanism 28 is generally upstanding and extends into the living space of the RV 20, the principles of the present invention are applicable where such supporting structure is oriented differently relative to the chassis 26.

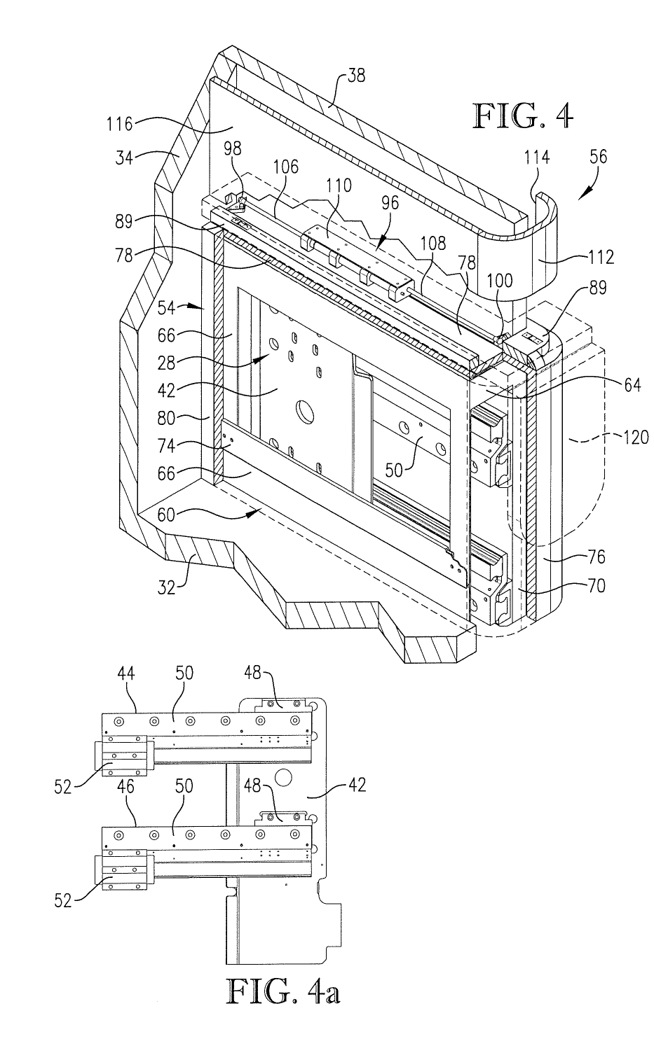

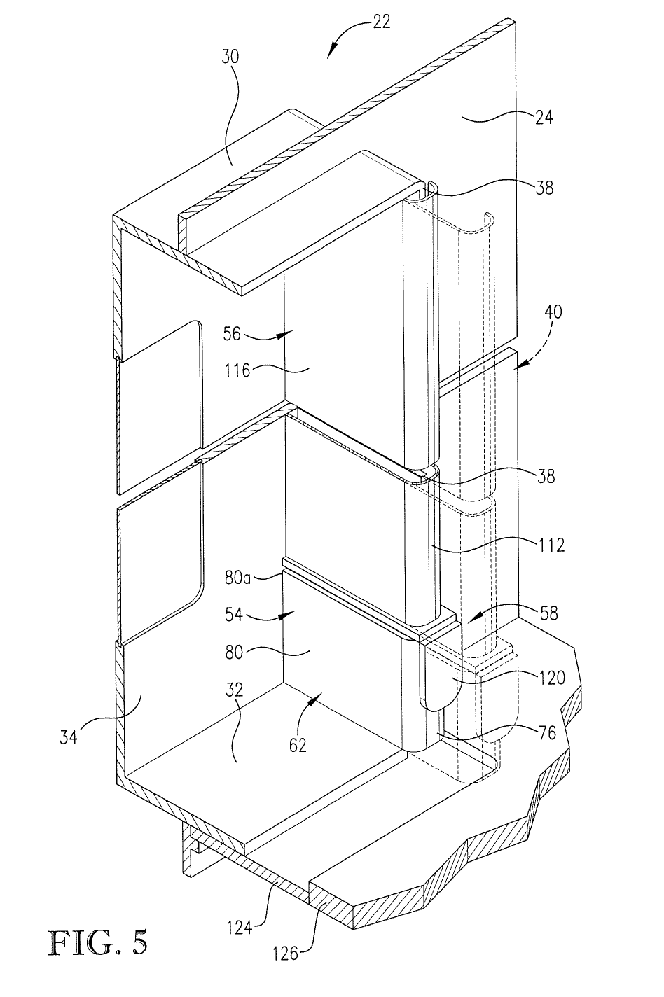

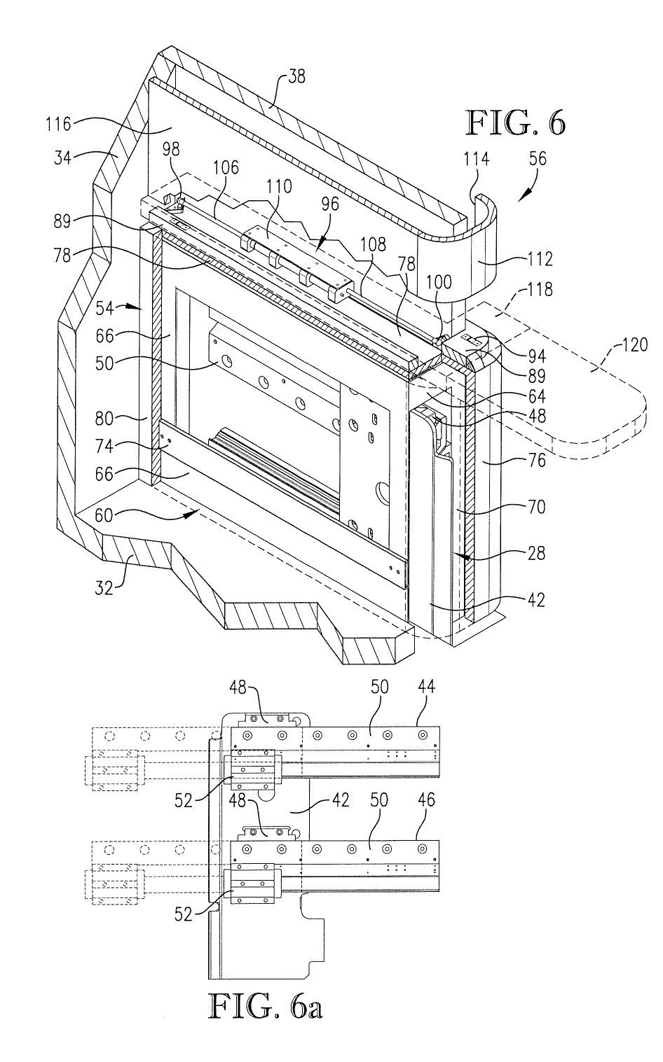

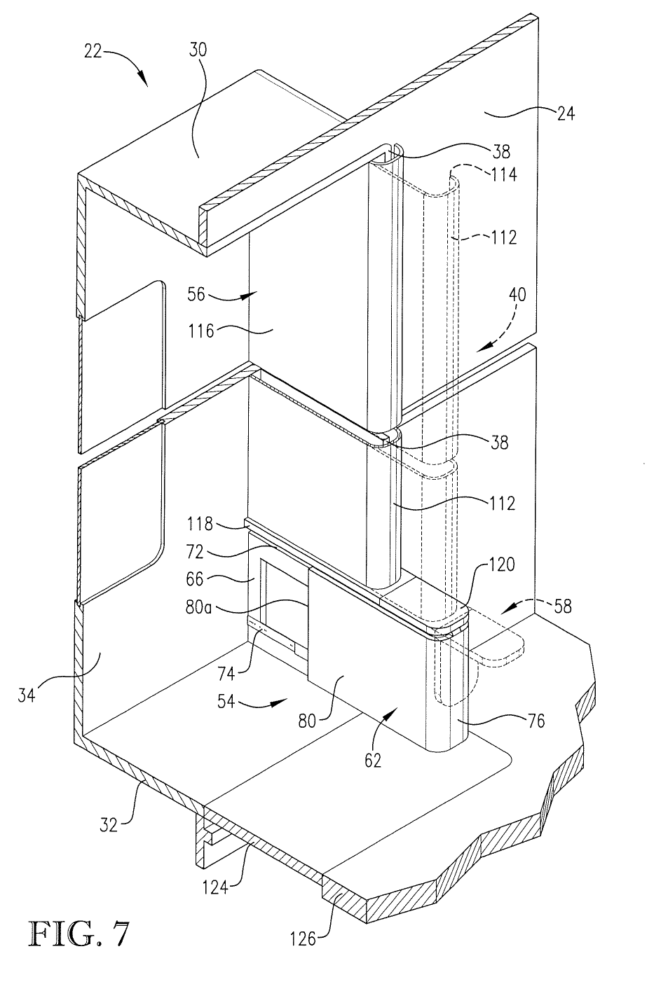

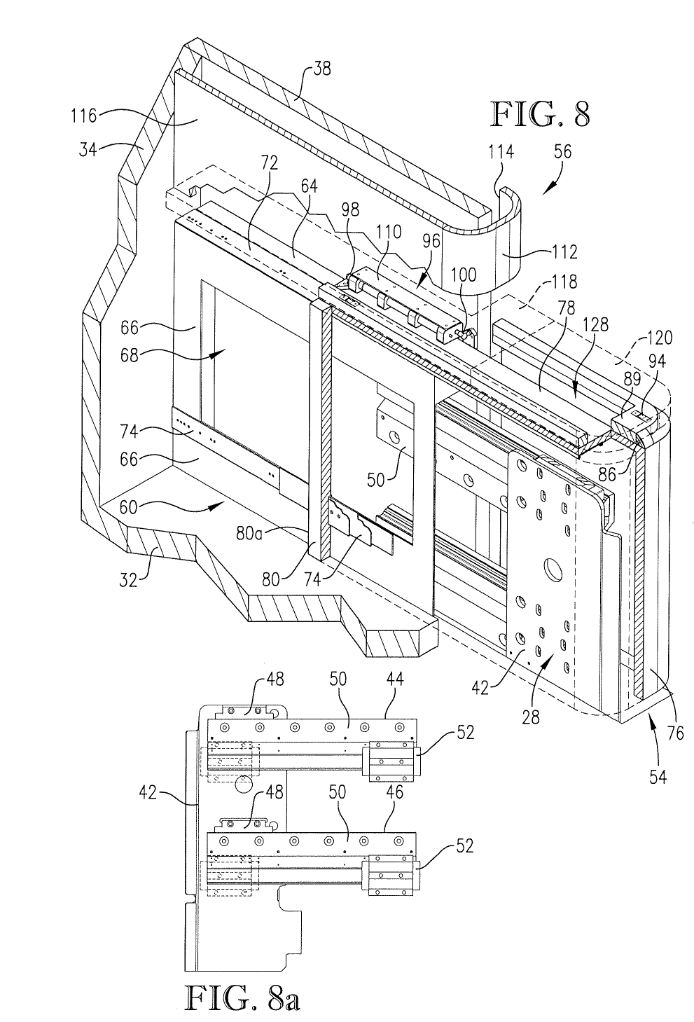

As previously discussed, the slide-out 22 is shiftably supported on the chassis 26 by the bearing mechanism 28 and is selectively shiftable between the extended position (see FIG. 8) and the retracted position (see FIG. 4). In the retracted position, the fixtures 52 are spaced inboard of the plate 42 at a farthest inboard position and the slide arms 50 extend in an inboard direction from the plate 42. The slide-out 22 is shiftable from the retracted position to an intermediate position (see FIGS. 5 and 6) where the slide arms 50 extend in an outboard direction from the plate 42 and the fixtures 52 have shifted in the outboard direction from the farthest inboard position. The slide-out 22 is shiftable from the intermediate position to the extended position (see FIGS. 7 and 8) where the fixtures 52 are spaced outboard of the plate 42 (see FIG. 8a) at a farthest outboard position and the slide arms 50 extend in the outboard direction. While the illustrated bearing mechanism 28 is preferred for supporting the slide-out 22, the principles of the present invention are applicable whether other types of bearing supports are used.

As discussed, the cover assemblies 40 receive and cover the sidewalls 36,38 and bearing mechanism 28 during movement between the extended and retracted positions. The cover assembles 40 associated with the respective slide-out sidewalls 36,38 each broadly include, among other things, a lower segment 54, an upper segment 56, and a sliding, sectionalized cover 58. As will be described in greater detail, the assemblies 40 are designed to move with the sidewalls 36,38 during shifting of the slide-out 22, in order to provide the desired aesthetic appearance within the RV 20 at all positions of the slide-out 22. Again, the assemblies 40 also hide and cover the bearing mechanism 28 for the purpose of safety and generally provide other advantages. While the illustrated cover assemblies 40 are preferably used in connection with sidewalls 36,38, it is also consistent with the principles of the present invention where such cover assemblies 40 are used with the top wall 30, bottom wall 32, or other wall structures associated with slide-outs. Furthermore, the principles of the present invention are equally applicable where the cover assemblies 40 are generally oriented in a position other than the illustrated generally upright position.

The lower segment 54 of cover assembly 40 includes an internal, metallic, stationary frame 60 disposed about the bearing mechanism 28, as well as an outer, shiftable, decorative cover 62. The substantially unitary frame 60 presents a generally U-shaped, inverted configuration and includes a laterally extending top segment 64 and an upright box-like structure 66 that presents a central opening 68. The frame 60 further includes an opposed, upright wall 70. The frame 60 is secured to the bottom wall 32 of slide-out 22 and thereby shifts with the slide-out 22.

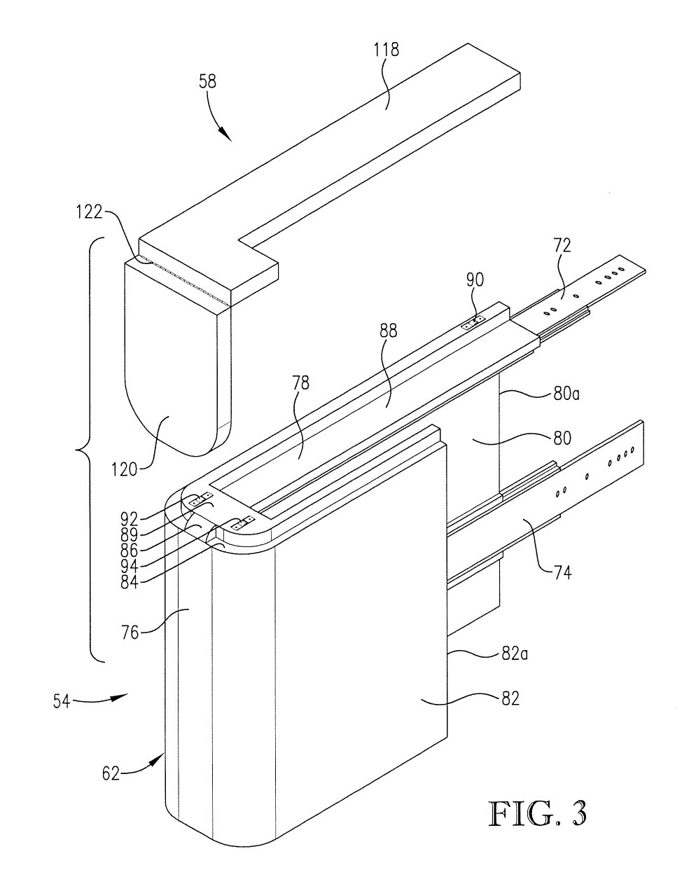

The frame 60 also includes a pair of multiple-section drawer-type slides 72,74 respectively secured to the top segment 64 and structure 66 (see FIGS. 3, 9, and 11). Each of the illustrated slides 72,74 includes three telescoping slide segments that permit selective extension of the slides 72,74. The innermost slide segment is preferably attached to the frame 60 with the outermost slide segment being attached to the cover 62. While the illustrated drawer-type slides 72,74 are preferable for slidably connecting the frame 60 and cover 62, it is within the ambit of the present invention to use other types of slide or bearing mechanisms for permitting such relative shifting movement.

The cover 62 also generally presents an inverted, U-shaped configuration, and preferably surrounds the frame 60 and mechanism 28. The cover 62 includes an inboard, upright, rounded nose section 76, a top panel 78, and a pair of spaced apart side panels 80,82 presenting butt ends 80a and 82a. As is perhaps best seen in FIG. 3, the cover 62 has a recessed upper margin 84 with a rounded cam segment 86 centrally located atop nose section 76. Additionally, the top panel 78 has a fore and aft extending section 88, as well as an upstanding, somewhat J-shaped marginal segment 89 supporting three rollers 90,92,94 on the upper surface thereof.

Again, the cover 62 is attached to the slides 72,74 so that the slides 72,74 slidably interconnect the cover 62 and frame 60. The cover 62 is operable to slide relative to the frame 60 between a fully covered position (see FIGS. 2 and 4-6), where the cover 62 substantially covers the frame 60 along the length thereof, and a partly covered position (see FIGS. 7 and 8) where the cover 62 partly covers the frame 60. As will be discussed, such sliding movement permits the cover 62 to move relative to the remainder of the slide-out 22 under certain situations and move with the remainder of the slide-out 22 in other situations.

The cover 62 also is operable to shift relative to and selectively receive the sidewall 38. In the retracted position, the cover 62 fully receives the sidewall 38 so that an inboard end of the sidewall 38 contacts the cover 62. In the extended position, the cover 62 only partly receives the sidewall 38 with a gap 95 being formed between the inboard sidewall end and an inner surface of the marginal segment 89 that faces the sidewall 38. The gap 95 becomes smaller as the slide-out 22 shifts from the extended position to the intermediate position and becomes negligible as the slide-out 22 approaches the intermediate position. As will be discussed, the cover 58 is operable to cover or overlie the gap 95 in the retracted and extended positions and at positions therebetween.

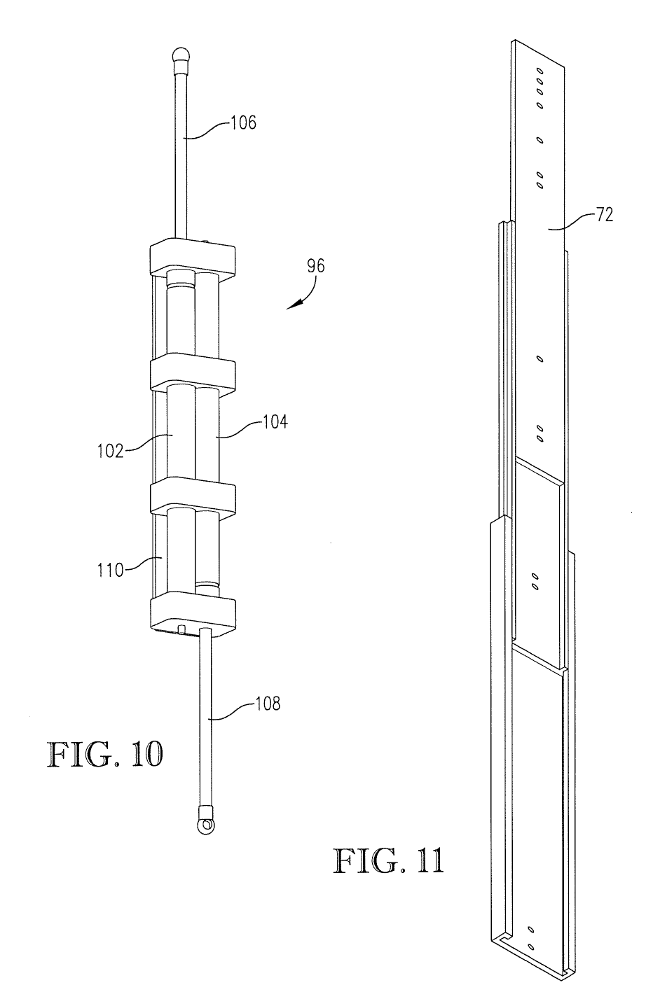

As best illustrated in FIGS. 4, 6 and 10, the cover assemblies 40 each preferably include a spring assist device 96 located above the top panel 78 and secured by end brackets 98,100 to the cover 62 and sidewall 38, respectively. The device 96 preferably includes identical gas springs 102,104 each having an outwardly extending operating arm 106,108 that is biased into an outermost position from the spring body. The gas springs 102,104 are secured together by a bracket 110, with the arms 106,108 extending in opposite directions.

Again, the device 96 interconnects the cover 62 and sidewall 38 and controls the relative sliding position thereof. In particular, the device 96 tends to force the sidewall 38 to be received in the cover 62 until the inboard end of the sidewall 38 contacts the cover 62 (see FIG. 4). The device 96 preferably applies a relatively small force between the sidewall 38 and cover 62 when the sidewall 38 is fully received by the cover 62, e.g., when the slide-out 22 is in the retracted position. The device 96 also preferably applies a relatively large force between the sidewall 38 and cover 62 when the sidewall 38 is only partly received by the cover 62 (see FIG. 8), e.g., when the slide-out 22 is in the extended position. While the illustrated spring assist device 96 is preferable for providing smooth operation of the cover 62, the principles of the present invention are applicable where other mechanisms are used to control the relative position of the sidewall 38 and cover 62.

Thus, the illustrated lower segment 54 is operable to remain in a covering relationship with respect to the bearing mechanism 28, particularly the plate 42, as the slide-out 22 shifts into the extended position. As the slide-out 22 shifts from the extended position to the retracted position, the lower segment 54 is also operable to shift itself toward the sidewall 38 so as to occupy a minimal amount of internal vehicle space.

The upper segment 56 is generally J-shaped in cross-section and includes an inboard, upright, rounded nose section 112 terminating in a butt edge 114, as well as an inner side panel 116. The upper segment 56 is preferably attached to the corresponding sidewall 38. However, the principles of the present invention are applicable where the upper segment 56 is shiftable relative to the sidewall 38 in a manner similar to the lower segment 54. Thus, the upper segment 56 is operable to shift relative to the lower segment 54. As shown, the upper segment 56 presents a similar outermost shape when compared to the outer wall structure, i.e., nose section 76 and side panels 80,82, of the lower segment 54 in order to create a pleasing aesthetic appearance. In particular, the similar outer shape of the lower and upper segments 54,56 permits the segments 54,56 to be superposed when the slide-out 22 is between the retracted and intermediate positions.

Initially, when the slide-out 22 is in the retracted position, the nose sections 76,112 are preferably laterally adjacent to one another. As the slide-out 22 moves from the retracted position to the intermediate position, or vice-versa, the lower and upper segments 54,56 move in unison with each other. When the slide-out 22 moves from the intermediate position to the extended position, the upper segment 56 becomes generally spaced outboard of the lower segment 54. More particularly, the nose section 112 becomes preferably spaced laterally outboard of the nose section 76. This occurs because the lower segment 54 remains in the covering relationship with respect to the bearing mechanism 28.

Turning to FIGS. 3 and 9, the cover 58 includes a generally L-shaped piece 118 as well as an inboard, rounded cover piece 120. The cover piece 120 is pivotally secured to the inboard end of piece 118 with a piano-type hinge 122. The piece 118 is preferably attached to the underside of upper segment 56 (at an attachment location not shown), and thus travels with segment 56 during movement of slide-out 22. Furthermore, the cover 58 is rollably supported on rollers 90,92,94 and is thereby operable to shift relative to lower segment 54.

In the fully retracted position of slide-out 22, the cover piece 120 extends downwardly into a stowed position and engages nose section 76 (see FIGS. 2 and 4). As the slide-out 22 shifts from the retracted position to the intermediate position, the cover piece 120 substantially remains in the stowed position. As the slide-out 22 shifts from the intermediate position to the extended position, the piece 118 moves outboard relative to cover 62 and cover piece 120 pivots upwardly from the stowed position into a laterally-extending orientation so that the cover 58 extends uniformly along a lateral direction. When the slide-out 22 reaches the extended position, the cover 58 overlies the gap 95 and presents an inboard edge 123, which is preferably adjacent an inboard surface of the nose section 76 so that the edge 123 and inboard surface are substantially flush with each other. When the slide-out 22 is shifted out of extended position, the piece 118 move inboard relative to the cover 62, with the cover piece 120 pivoting downwardly until the cover piece 120 reaches the stowed position. In the stowed position, the inboard edge 123 is again adjacent the inboard surface of the nose section 76. In this manner, the cover piece 120 is only minimally spaced inboard of the nose section 76.

In operation, the slide-out 22 initially shifts from the retracted position (see FIG. 2) to the intermediate position (see FIG. 5). During this sequence, the entire slide-out 22 moves outwardly relative to the RV sidewall 24 and a pop-up floor section 124 forming a part of an RV floor 126. In this initial stage of motion, the lower segment 54 moves in unison with the upper segment 56, with both segments 54,56 moving relative to the chassis 26. This movement is permitted by the slide assemblies 44,46. In the intermediate position shown in FIG. 5, the butt end 80a of side panel 80 engages the outboard wall 34, butt end 82a of panel 82 engages RV sidewall 24, and cover piece 120 remains in its downwardly extending orientation against nose piece 76.

In the second stage of operation between the intermediate position and the fully extended position, the lower segment 54 remains stationary while upper section 56 and the walls of slide-out 22 extend outwardly. Such relative motion is again permitted by the assemblies 44,46. In this final position, the butt end 114 of nose section 112 engages RV sidewall 24, and floor section 124 moves upwardly to a flush orientation relative to RV floor 126.

It will also be noted that during the entire movement of slide-out 22, and particularly between the intermediate and final positions thereof, the device 96 creates a constant biasing force ensuring smooth and controlled operation of cover 62 and avoiding any sudden or jerky movements thereof.

Of course, the opposite movement of slide-out 22 from the extended to the retracted positions thereof occurs in a reverse fashion, i.e., between the fully extended and intermediate positions the lower segment 54 is stationary and the upper segment 56 moves relative to it. From the intermediate position to the retracted position, both segments 54 and 56 move in unison until the retracted position is achieved.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A vehicle having an interior living area, said vehicle comprising:
a vehicle chassis;
a slide-out moveable between retracted and extended positions, with the slide-out serving to expand the living area when in the extended position thereof,
said slide-out including a laterally-extending wall that shifts laterally relative to the vehicle chassis as the slide-out moves between the extended and retracted positions thereof, and
a bearing mechanism shiftably supporting the slide-out on the chassis for movement between the extended and retracted positions,
said slide-out including a cover assembly disposed about at least a portion of the bearing mechanism so as to cover the at least a portion of the bearing assembly from the living area,
said cover assembly including a base segment that is moveable relative to the laterally-extending wall,
said base segment and laterally-extending wall cooperatively defining a gap that changes in size as the slide-out moves between the extended and retracted positions thereof,
said cover assembly including a cover segment that is in a covering relationship with the gap.

2. The vehicle as claimed in claim 1,
said cover segment being shiftable relative to the base segment.

3. The vehicle as claimed in claim 2,
said gap decreasing in size as the slide-out moves from the extended position to the retracted position,
said cover segment being at least partly collapsible as the slide-out moves into the retracted position thereof.

4. The vehicle as claimed in claim 3,
said cover segment including a first section and a second section that is swingable relative to the first section to a stowed position when the slide-out is in the retracted position thereof.

5. The vehicle as claimed in claim 4,
said base segment presenting an innermost surface spaced inboard of the laterally-extending wall and a lateral surface substantially perpendicular to the innermost surface, with the gap being defined in the lateral surface,
said second section being generally parallel to the lateral surface when the slide-out is in the extended position and generally parallel to the innermost surface when the second section is in the stowed position.

6. The vehicle as claimed in claim 4,
said first section being fixed relative to the laterally-extending wall.

7. The vehicle as claimed in claim 3,
said cover segment including first and second sections projecting from an intermediate location, with the second section being collapsible,
said base segment presenting an innermost surface spaced inboard of the laterally-extending wall,
said second section presenting an innermost edge spaced in a lateral direction from the intermediate location, with the innermost edge being inboard of the intermediate location when the slide-out is in the extended position thereof,
said intermediate location and innermost edge cooperatively defining therebetween a distance measured along the lateral direction that decreases as the slide-out moves from the extended to retracted positions thereof.

8. The vehicle as claimed in claim 7,
said innermost edge being adjacent the innermost surface of the base segment when the slide-out is in the extended and retracted positions thereof.

9. The vehicle as claimed in claim 1,
said gap decreasing in size as the slide-out moves from the extended position to the retracted position,
said cover assembly disposed about at least a portion of the laterally-extending wall,
said base segment presenting an inboard end that is spaced inboard of the laterally-extending wall, with the gap being defined therebetween,
said inboard end being closer to the laterally-extending wall when the slide-out is in the retracted position than when the slide-out is in the extended position, with the gap correspondingly changing in size.

10. The vehicle as claimed in claim 1,
said laterally-extending wall being substantially upright,
said cover assembly including an upper segment spaced above the base segment,
said cover assembly being a false wall associated with the laterally-extending wall,
said upper segment being fixed relative to the laterally-extending wall, with the upper segment and base segment being slidable relative to one another.

11. The vehicle as claimed in claim 10,
said cover assembly presenting an innermost surface spaced inboard of the laterally-extending wall,
said base and upper segments presenting corresponding lower and upper portions of the innermost surface,
said upper surface portion being spaced laterally outboard from the lower surface portion when the slide-out is in the extended position,
said surface portions being laterally adjacent to one another when the slide-out is in the retracted position.

12. The vehicle as claimed in claim 11,
said cover segment extending laterally from one of the surface portions to the other when the slide-out is in the extended position,
said upper surface portion being shifted inwardly toward the lower surface portion when the slide-out is shifted from the extended position,
said cover segment being fixed relative to the upper segment, with the cover segment presenting an innermost edge adjacent the lower surface portion when the slide-out is in the extended and retracted positions thereof.

13. The vehicle as claimed in claim 10,
said cover segment having a pivotally mounted inboard cover section movable between a generally depending position when the slide-out is in the retracted position, and a generally horizontal gap-covering position when the slide-out is in the extended position.

14. The vehicle as claimed in claim 13,
said cover segment having an outboard section operably coupled with a lower end of the adjacent upper segment,
said inboard cover section being hingedly secured to the outboard cover section.

15. The vehicle as claimed in claim 14,
said base segment presenting an arcuate camming surface operable to engage and smooth the pivotal movement of the inboard cover section.

16. The vehicle as claimed in claim 10,
said base and upper segments operable to move substantially in unison between the retracted position and an intermediate position of the slide-out,
said upper segment operable to move relative to the base segment between the intermediate position and the extended position of the slide-out.

17. The vehicle as claimed in claim 16,
said base segment being stationary during movement of the slide-out between the intermediate and extended positions thereof.

18. The vehicle as claimed in claim 1,
said base segment including a plurality of rollers mounted in an upper margin thereof and oriented to rollably support the cover segment.

19. The vehicle as claimed in claim 1,
said cover assembly including a gas spring operator assembly coupled between the base segment and the laterally-extending wall and operable to force the base segment away from the wall.

20. The vehicle as claimed in claim 1,
said laterally-extending wall being upright and presenting a laterally outboard end,
said slide-out including an outboard wall adjacent the laterally outboard end of the laterally-extending wall,
said base segment having an upright inboard wall and upright sidewall panels extending from the inboard wall on opposite sides of the laterally-extending wall toward the outboard wall.

21. A vehicle slide-out bearing cover operable to shift relative to one of the slide-out sidewalls as the slide-out moves between retracted and extended positions, the vehicle slide-out bearing cover comprising:
a base segment presenting an open-ended slot configured to shiftably receive the one sidewall of the slide-out as the slide-out moves between the extended and retracted positions, wherein the base segment is adapted to define a variously sized gap within the slot as the slide-out moves between the extended and retracted positions; and
a cover segment shiftable relative to the base segment,
said cover segment operable to be fixedly attached relative to the sidewall so as to be shiftable as the sidewall shifts into and out of the slot, with the cover segment thereby covering the gap in the retracted and extended positions,
said cover segment including a first section and a second section that is swingable relative to the first section to a stowed position when the slide-out is in the retracted position thereof.

22. The vehicle slide-out bearing cover as claimed in claim 21,
said second section configured to be in a covering position relative to the gap when the slide-out is in the extended position,
said base segment presenting an innermost surface operable to be spaced inboard of the sidewall and a lateral surface substantially perpendicular to the innermost surface, with the gap being defined in the lateral surface,
said second section being generally parallel to the lateral surface when in the covering position and generally parallel to the innermost surface when in the stowed position.

23. The vehicle slide-out bearing cover as claimed in claim 21,
said second section configured to be in a covering position relative to the gap when the slide-out is in the extended position,
said first and second sections projecting from an intermediate location,
said base segment presenting an innermost surface operable to be spaced inboard of the sidewall,
said second section presenting an innermost edge spaced in a lateral direction from the intermediate location, with the innermost edge being inboard of the intermediate location when the second section is in the covering position thereof,
said intermediate location and innermost edge cooperatively defining therebetween a distance measured along the lateral direction that decreases as the second section is moved toward the stowed position.

24. The vehicle slide-out bearing cover as claimed in claim 23,
said innermost edge being adjacent the innermost surface of the base segment when the second section is in the stowed position.

25. The vehicle slide-out bearing cover as claimed in claim 21; and
an upper segment spaced above the base segment,
said vehicle slide-out bearing cover being a false wall configured to be associated with the sidewall,
said upper segment operable to be fixed relative to the sidewall, with the upper segment and base segment being slidable relative to one another.

26. The vehicle slide-out bearing cover as claimed in claim 25,
said vehicle slide-out bearing cover presenting an innermost surface configured to be spaced inboard of the sidewall,
said base and upper segments presenting corresponding lower and upper portions of the innermost surface,
said second section configured to be in a covering position relative to the gap when the slide-out is in the extended position,
said upper surface portion being spaced laterally outboard from the lower surface portion when the second section is in the covering position,
said surface portions being laterally adjacent to one another when the second section is in the stowed position.

27. The vehicle slide-out bearing cover as claimed in claim 26,
said cover segment extending laterally from one of the surface portions to the other when the second section is in the covering position,
said upper surface portion being shifted inwardly toward the lower surface portion when the second section is shifted from the covering position,
said cover segment being fixed relative to the upper segment, with the cover segment presenting an innermost edge adjacent the lower surface portion when the second section is in the covering and stowed positions thereof.

28. The vehicle slide-out bearing cover as claimed in claim 25,
said second section being generally depending from the first section when the second section is in the stowed position.

29. The vehicle slide-out bearing cover as claimed in claim 28,
said first section being operably coupled with a lower end of the adjacent upper segment,
said second section being hingedly secured to the first section.

30. The vehicle slide-out bearing cover as claimed in claim 29,
said base segment presenting an arcuate camming surface operable to engage and smooth the pivotal movement of the second section.

31. The vehicle slide-out bearing cover as claimed in claim 25,
said base and upper segments operable to move substantially in unison between the retracted position and an intermediate position of the slide-out,
said upper segment operable to move relative to the base segment between the intermediate position and the extended position of the slide-out.

32. The vehicle slide-out bearing cover as claimed in claim 31,
said base segment configured to be stationary during movement of the slide-out between the intermediate and extended positions thereof.

33. The vehicle slide-out bearing cover as claimed in claim 21,
said base segment including a plurality of rollers mounted in an upper margin thereof and oriented to rollably support the cover segment.

34. The vehicle slide-out bearing cover as claimed in claim 21; and
a gas spring operator assembly operable to be coupled between the base segment and the sidewall and thereby force the base segment away from the sidewall.
